(19) United States
(12) Patent Application Publication
(10) Pub. No.: US 2026/0097673 A1
(43) Pub. Date: Apr. 9, 2026

(54) PARKING GUIDANCE SYSTEM FOR SOLAR PANEL-EQUIPPED VEHICLES AND METHOD THEREOF

(71) Applicants: HYUNDAI MOTOR COMPANY, Seoul (KR); Kia Corporation, Seoul (KR)

(72) Inventor: Dong Hyun LIM, Gyeonggi-do (KR)

(21) Appl. No.: 19/353,547

(22) Filed: Oct. 8, 2025

(30) Foreign Application Priority Data
Oct. 8, 2024 (KR) 10-2024-0136521

(51) Int. Cl. B60L 53/51; B60L 8/00; H02S 20/30

(52) U.S. Cl. CPC B60L 53/51; B60L 8/003; H02S 20/30; B60L 2240/62; B60L 2240/665; B60L 2240/72; B60L 2250/16

(57) ABSTRACT

A parking guidance system for a solar panel-equipped vehicle and a method therefor. The parking guidance system for the solar panel-equipped vehicle includes a server including a communications unit that periodically collects solar intensity messages from solar panel-equipped vehicles; a map generation unit that accumulates the solar power intensity messages and generates a variable solar power map (VSPM) including a precise map (P-Map) of an outdoor parking lot based on the accumulated data; a database DB that stores the VSPM and periodically updates a regional solar intensity information over a time; and a control unit that provides an optimal solar charging parking location with a strongest solar intensity based on a vehicle location of a customer to the vehicle based on the VSPM.

### CROSS-REFERENCE TO RELATED APPLICATION

Pursuant to 35 U.S.C. § 119(a), this application claims the benefit of an earlier filing date and right of priority to Korean Patent Application No. 10-2024-0136521 filed with the Korean Intellectual Property Office on October 8, 2024, the entire contents of which are incorporated herein by reference.

### TECHNICAL FIELD

The present disclosure relates to a parking guidance system.

### BACKGROUND

As the need for an eco-friendly mobility increases, various electric vehicles (xEV: X Electric Vehicle) and hydrogen vehicles are being introduced into the market. In addition, the spread of purpose-built vehicles (PBVs) that may be designed to meet specific purposes of customers is expanding.

When it comes to the eco-friendly mobility, driving range is a sensitive issue. Accordingly, manufacturers are introducing various technologies to increase driving range, such as solar panels, e.g., a solar roof.

The solar roof is a device that converts sunlight into electrical energy and charges a battery through solar panels, e.g., mounted on the roof of the vehicle. The solar roofs are a power generation method that uses a clean, unlimited solar energy, and have advantages of being environmentally friendly as they do not emit harmful substances or generate noise during the power generation process.

On the other hand, the solar roofs have the disadvantage that their charging efficiency varies or decreases depending on natural conditions such as season (spring, summer, fall, winter), time (day and night), and surrounding environment (sunny and shady), due to the nature of using the solar energy. For example, the solar roof may produce a maximum output (e.g. 200 W) when the sunlight incidence angle is optimally close to a vertical. However, because the sun moves from east to west over time, the angle of the solar incidence on the solar roof constantly changes. Additionally, because the sun's altitude changes depending on the seasons, the optimal incident angle of the solar does not last for a long time. Therefore, the maximum output of the solar roof is only available during some hours of sunlight, and it has the disadvantage of the charge being low thereof.

Accordingly, a technique is required that may guide customers to efficiently use the solar roof applied to their vehicles under the optimal conditions of a given environment.

The above information disclosed in this Background section is only for enhancement of understanding of the background of the disclosure and therefore it may contain information that does not form the prior art that is already known in this country to a person of ordinary skill in the art.

### SUMMARY

According to one aspect of the present disclosure, a parking guidance system for a solar panel-equipped vehicle including a server includes a communications unit that periodically collects solar intensity messages from solar panel-equipped vehicles; a map generation unit that accumulates the solar power intensity messages and generates a variable solar power map (VSPM) including a precise map (P-Map) of an outdoor parking lot based on the accumulated data; a database DB that stores the VSPM and periodically updates a regional solar intensity information over a time; and a control unit that provides an optimal solar charging parking location with a strongest solar intensity based on a vehicle location of a customer to the vehicle based on the VSPM.

The solar intensity may be measured based on an amount of a solar power generation or an electric energy charging amount per unit area of the solar panel over a time.

In the VSPM, an information on the intensity of the sunlight that changes according to a time, a season, a weather, and a terrain for a navigation map and an outdoor parking lot may be generated based on an actual data collected from a large number of vehicles in each region.

The controller may collect the parking status of an outdoor parking lot into which a vehicle has entered through the communication unit to identify an empty parking location on the P-Map, and determine the optimal solar-charged parking location with the strongest sunlight intensity among the currently empty parking locations.

The map generation unit may analyze the sunlight intensity message to identify a sunlight intensity, a vehicle location, a time, and a vehicle ID and accumulates the identified data into a database.

The map generation unit may generate the VSPM displayed on a map in a form of a heat map by excluding a data with a certain upper/lower ratio of the sunlight intensity from the accumulated data as outliers and matching the sunlight intensity corresponding to the remaining average data with a GPS value.

The map generation unit may update the heat map of the sunlight intensity that changes periodically at regular intervals on the map to sequentially generate multiple maps per a day.

The control unit may identify the entered outdoor parking lot and the entry time based on the vehicle location of the vehicle that has entered the outdoor parking lot, and detect the current P-Map corresponding to the entry time among multiple P-Maps matched to the outdoor parking lot in the DB.

The controller may collect a full empty vehicle information from the parking lot manager of the outdoor parking lot and matches the identified empty parking locations to the current P-Map.

The controller may match movement of a first customer vehicle entering the outdoor parking lot and an empty parking spot detected from an image captured by a front camera of a second customer vehicle parked therein to the current P-Map.

The controller may receive a parking location when the vehicle is completely parked, and then detects and transmits to the above vehicle an optimal solar-charged parking location among the currently empty parking locations after a certain period of time from the above parking completion time.

According to one aspect of the present disclosure, a solar panel-equipped vehicle parking guidance system includes a vehicle including a solar panel converting a solar energy into an electrical energy to generate s DC voltage; a solar charging controller that converts the DC voltage into a DC voltage that is chargeable to a battery to be charged; and a vehicle terminal which generates a solar intensity message including at least one of a vehicle location, a time, and a vehicle ID on a solar intensity periodically measured by the solar charging controller to be transmitted to a server, and receives an optimal solar charging parking location with a strongest solar intensity based on the vehicle location from the server to be provided to the driver.

The vehicle terminal, when it is determined that the vehicle location has entered an outdoor parking lot, may request an optimal solar charging parking location to the server and provide a route guidance to the optimal solar charging parking location received from the server as a destination.

The solar panel-equipped vehicle parking guidance system may further include a user terminal that controls a remote smart parking function to the changed optimal solar charging parking location by linking with the vehicle through a connected service app (APP).

According to one aspect of the present disclosure, a method for guiding a parking of a vehicle equipped with a solar panel includes collecting a solar intensity from a number of vehicles distributed across regions to build a variable solar power map (VSPM) by a server; receiving a request for an optimal charging parking location including a vehicle location and an entry time, from the vehicle entering an outdoor parking lot by the server; detecting an optimal solar charging parking location with a strongest solar intensity based on a vehicle location based on the VSPM matched to the outdoor parking lot according to the optimal charging parking location request by the server; and transmitting the optimal solar charging parking location to the vehicle via a wireless communication by the server.

Building the VSPM may include analyzing the collected sunlight intensity message to identify the vehicle location, the time, and the vehicle ID and to accumulate the identified data by the server excluding a data with a certain upper/lower ratio of the sunlight intensity from the accumulated data as a outlier; and matching the solar intensity corresponding to the remaining average data with a GPS value thereof to be displayed on a map in a form of a heat map.

Detecting the optimal solar charging parking location may include extracting a precise map (P-Map) of an outdoor parking lot for a time zone matching the entry point among the VSPMs stored in the DB by the server; collecting the parking status of the outdoor parking lot and identifying the empty parking locations remaining on the P-Map; and determining an optimal solar charging parking location with the strongest sunlight intensity among the empty parking locations.

After transmitting the optimal solar charging parking location to the vehicle, updating the parking status of the P-Map by reflecting an empty parking spot detected from an image captured by a front camera when the vehicle that enters the outdoor parking lot moves and completes the parking by the server may be further included.

After updating the parking status of the above P-Map, transmitting a change in the optimal solar charging parking location to the user terminal after a certain period of a time from the time of the completion of the parking of the vehicle by the server; receiving a request for the current optimal charging parking location from the vehicle in which a remote smart parking function is activated according to a command to the change of the parking location of the user terminal; and re-detecting the changed optimal solar charging parking location among the currently empty parking positions according to the request to be responded to the vehicle may be further included.

Building the VSPM may include updating the heat map of the sunlight intensity that changes periodically at regular intervals on the map to sequentially generate multiple maps per a day.

### BRIEF DESCRIPTION OF THE DRAWINGS

FIG. 1 is a view schematically illustrating an example of a configuration of a parking guidance system for a solar panel-equipped vehicle according to an implementation of the present disclosure.

FIG. 2 is a block diagram schematically showing an example of a configuration of a vehicle and a server according to an implementation of the present disclosure.

FIG. 3 is a view illustrating an example of generating a variable sunlight intensity map (VSPM) according to an implementation of the present disclosure.

FIG. 4 is a view illustrating an example of a method for identifying empty parking locations in an outdoor parking lot with a full empty vehicle information according to an implementation of the present disclosure.

FIG. 5 is a view illustrating an example of a method for identifying empty parking locations in an outdoor parking lot without a vacancy information according to an implementation of the present disclosure.

FIG. 6 is a flowchart illustrating an example of a method for guiding a parking of a vehicle equipped with solar panels when there is an outdoor parking lot map (P-Map) in a DB of a server according to a first implementation of the present disclosure (CASE 1).

FIG. 7 is a view showing an example of an alarm status of a change parking location of a user terminal according to an implementation of the present disclosure.

FIG. 8 is a flowchart illustrating an example of a method for guiding a parking of a vehicle equipped with solar panels when there is no outdoor parking lot map (P-Map) in a DB of a server according to the second implementation of the present disclosure (CASE 2).

### DETAILED DESCRIPTION

The present disclosure relates to a parking guidance system for a solar panel-equipped vehicle and a method thereof, and more particularly, to a parking guidance system for a solar panel-equipped vehicle and a method thereof which can determine an improved solar charging parking location for a vehicle based on a self-produced solar intensity map.

An implementation of the present disclosure provides a parking guidance system for a solar panel-equipped vehicle and method thereof, which constructs a variable solar power map (VSPM) using a solar intensity data collected from a plurality of solar panel-equipped vehicles for different regions, and provides a recommended parking location for solar charging, based on the real-time vehicle location of the customer based on the map.

Hereinafter, the present disclosure will be described more fully hereinafter with reference to the accompanying drawings, in which implementations of the disclosure are shown.

The terminology used herein is for the purpose of describing particular implementations only and is not intended to be limiting of the present disclosure. As used herein, the singular forms are intended to include the plural forms as well, unless the context clearly indicates otherwise. As used herein, the term "comprises" and/or "comprising" refers to the presence of specified features, integers, steps, acts, elements and/or components, but it should also be understood that it does not exclude a presence or an addition of one or more other features, integers, steps, acts, components, and/or groups thereof. As used herein, the term “and/or” includes any one or all combinations of one or more related items.

Throughout the specification, terms such as “first”, “second”, “A”, “B”, “(a)”, “(b)”, etc. may be used to describe various elements, but the elements should not be limited by the terms. These terms are used only to differentiate the components from other components, but the nature, sequence, order, etc. of the corresponding components are not limited by these terms.

Also, in this specification, it is to be understood that when one component is referred to as being “connected” or “coupled” to another component, it may be connected or coupled directly to the other component or may be connected or coupled to the component with another component intervening therebetween. On the other hand, in this specification, it is to be understood that when one component is referred to as being “connected or coupled directly” to another component, it may be connected or coupled to the other component without another component intervening therebetween.

Terms used in the present specification are used only to describe specific implementations, and are not intended to limit the present disclosure. Singular expressions used herein include plural expressions unless they have definitely opposite meanings in the context.

Additionally, it is understood that one or more of the methods or aspects thereof below may be executed by at least one controller. The term "controller" may refer to a hardware device that includes a memory and a processor. The memory is configured to store program instructions, and the processor is specifically programmed to execute the program instructions to perform one or more processes described in more detail below. The controller may control the operation of units, modules, components, devices, or the like, as described herein. Additionally, it is understood that the methods below may be implemented by a device including a controller together with one or more other components, as will be appreciated by those skilled in the art.

Now, a parking guidance system for a solar panel-equipped vehicle and a method thereof according to an implementation of the present disclosure will be described in detail with reference to attached drawings.

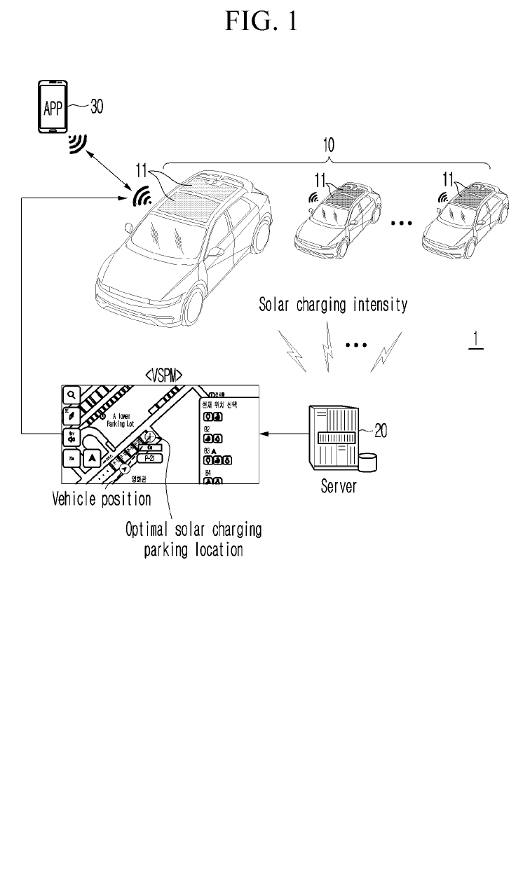

FIG. 1 is a view schematically illustrating an example of a configuration of a parking guidance system for a solar panel-equipped vehicle according to an implementation of the present disclosure.

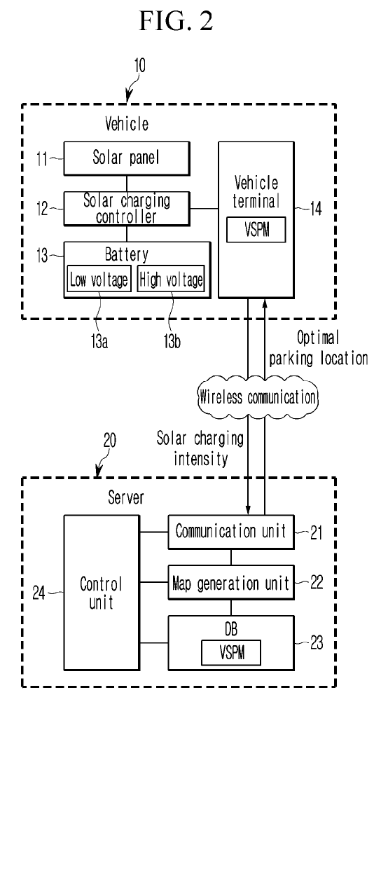

FIG. 2 is a block diagram schematically showing an example of a configuration of a vehicle and a server according to an implementation of the present disclosure.

Referring to FIGS. 1 and 2, a parking guidance system 1 for a solar panel-equipped vehicle according to an implementation of the present disclosure includes a vehicle 10 equipped with a solar panel 11. The vehicle measures (e.g., periodically) a sunlight intensity and a vehicle position and transmits the same to a remote computing system, e.g., server 20. The server 20 determines a fluctuation of solar energy generation across different times, different environments, different geographic locations, etc., for example by generating a variable solar power map (VSPM), using the sunlight intensity collected from a plurality of vehicles 10 distributed by each region. Based on the VSPM, the server 20 provides a recommended parking location for effective (e.g., optimal) solar charging with the strongest sunlight intensity based on the vehicle position of the customer. In some implementations, the system 1 further includes a user terminal 30 that has a connected service app (APP) installed for a remote control of the vehicle 10.

The solar intensity can be measured in various ways. For example, the solar intensity can be measured based on the amount of the solar power generation or the amount of the electric energy charge per unit area (e.g., a group of a solar cell) of the solar panel 11 over a time duration.

In some implementations, the recommended solar charging parking location can be a location where the charging intensity is the strongest based on the amount of the solar power generation or the amount of the electric energy charging at the same time within the predetermined area based on the vehicle location. This recommended solar charging parking location may be a location where the solar panel 11 satisfies one or more criteria, e.g., the solar panel surface being close to perpendicular to the angle of incidence of sunlight at the same time in a certain area based on the vehicle location.

The variable sunlight intensity map (VSPM) can be variable in that the sunlight intensity information applied to the map can change depending on a time, a season, a weather, a terrain, and/or other factors.

The VSPM can be generated based on actual data collected from a large number of vehicles in different regions of navigation and parking lots, e.g., outdoor parking lots. In some implementations, a realistic VSPM can be efficiently built based the actual measured data that reflects variation factors with minimal or no complex calculations that consider various variation factors that determine the solar intensity.

The vehicle 10 can be any type of automobile, including an electric vehicle (xEV), a purpose built vehicle (PBV), a hydrogen vehicle, and an internal combustion engine vehicle, equipped with the solar panel 11.

The vehicle 10 can include, for example, the solar panel 11, a solar charge controller 12, a battery 13, and a vehicle terminal 14. In addition, the vehicle 10 can implement wireless communication, infotainment, autonomous driving, and vehicle management functions for connected car services, which can be implemented by hardware and/or software.

The solar panel 11 can convert the solar energy into the electrical energy and generates a DC voltage.

The solar panel 11 can be implemented in an appropriate location of the vehicle 10. For example, the solar panel 11 can be a solar roof applied as an option to the roof of the vehicle 10, and the following description will be based on this scenario. However, the solar panel 11 is not limited thereto and may be applied to a part or a component (including a glass) of the body forming the appearance of the vehicle 10.

The solar panel 11 can be applied as a silicon type, a semi-transparent type, or a thin film type solar cell depending on the application area of the vehicle 10. In addition, a product with technologically advanced features such as a material, a structure, a power generation efficiency, and a durability of the solar panel may be selectively applied without being limited thereto.

The solar charge controller 12 may convert the DC voltage generated from the solar panel 11 into the DC voltage that may be charged to the battery 13 and charges it. The solar charge controller 12 measures (e.g., periodically) the solar power intensity, and can transmit the information to the vehicle terminal 14.

The solar charge controller 12 may convert the input DC voltage to charge a low-voltage battery 13a of 12 V or 24 V for the electric load operation or a high-voltage battery 13b for a driving motor. For example, the solar charge controller 12 includes a DC-DC converter function. In some implementations, this solar charge controller 12 may perform a maximum power point tracking (MPPT) to control a voltage and a current, e.g., to increase the efficiency of the power collected in the solar panel 11.

The vehicle terminal 14 can generate a message (hereinafter referred to as “a solar intensity message”) including various information related to the measured solar intensity, e.g., information including at least one of the current vehicle location (e.g., a GPS value), a time, and a vehicle ID (a communication NO) based on the solar intensity periodically measured by the solar charging controller 12. The vehicle terminal 14 can transmit the message to the server 20. Additionally, the vehicle terminal 14 can visually and audibly display information, e.g., a recommended parking location for solar charging, received from the server 20 to the driver.

The vehicle terminal 14 can transmit the solar intensity message, for example, by connecting a wireless communication and the server 20 through a vehicle communication means (CCU: Central Communication Unit). The wireless communication may be implemented by at least one of a mobile communication, V2X (Vehicle to Everything), and a V2N (Vehicle to Network).

In some implementations. the vehicle terminal 14 may be a vehicle information and communication terminal including a global positioning system (GPS) or a high-precision GPS, and can be implemented as a function integrated into, for example, audio video navigation (AVN) or infotainment system.

When the vehicle terminal 14 determines that the vehicle has entered an outdoor parking lot, it may request the server 20 for a recommended parking location for solar charging (hereinafter, also referred to as “a recommended parking location” for convenience). In addition, the vehicle terminal 14 can request the recommended parking location from the server 20 according to the driver's input request, in some scenarios.

Also, the vehicle terminal 14 can receive the recommended solar charging parking location based on the vehicle location according to the request from the server 20. The vehicle terminal 14 can provide a guidance towards the recommended parking location, for example a location with the strongest solar intensity. In some implementations, the vehicle terminal 14 can display a detailed map that provides route guidance to the recommended parking location (referred to herein as a Precise Map, or P-Map). The P-Map can be a map, e.g., of the outdoor parking lot, through navigation and provide a route guidance by identifying the recommended parking location, e.g., with the strongest sunlight intensity, among empty parking locations (idle parking spaces).

The server 20 can be implemented in various ways, for example, built into at least one of a customer management system of the vehicle manufacturer, a connected car service system, or a service system specialized for the parking guidance of the vehicles equipped with the solar panel.

The server 20 can include various processing and/or hardware components, a communication unit 21, a map generation unit 22, a database DB 23, and a control unit 24.

The communication unit 21 can include a wired and wireless communication means and transmits and can receive various types of information, such as information for parking guidance of the vehicle 10.

The communication unit 21 can, e.g., periodically, obtain the solar intensity messages from the vehicle 10.

The communication unit 21 can, in some implementations, obtain a real-time parking status, including occupied or unoccupied parking location information and the recommended parking location, from the parking lot manager (40) and the vehicle 10 in the outdoor parking lot.

The communication unit 21 can receive the recommended parking location request from the vehicle 10 and transmit the recommended solar charging parking location based on the vehicle location to the vehicle 10.

The map generation unit 22 can analyze the sunlight intensity message received from the communication unit 21 to identify the sunlight intensity, the vehicle location, the time, the vehicle ID, etc., and can accumulate the identified data into a database DB.

The map generation unit 22 can generate a variable sunlight intensity map VSPM including the precise map P-Map of the outdoor parking lot based on the DB data. For example, the P-Map can be a precise map of the outdoor parking lot. The P-Map can include, for example, the entrance/exit, passageway, unique parking location ID within the outdoor parking lot and the GPS value matched therewith. The VSPM can be provided to the vehicle equipped with the solar panels 11. In some implementations, the vehicle 10 can display the VSPM through the usual navigation system and display the P-Map matching thereto when entering the outdoor parking lot.

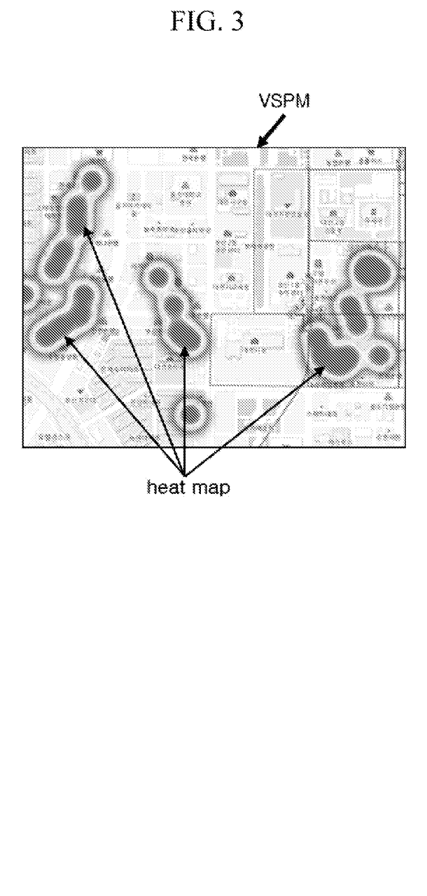

FIG. 3 is a view showing an example of generating a variable sunlight intensity map (VSPM) according to an implementation of the present disclosure.

Referring to FIG. 3, in some implementations, the map generation unit 22 can generate the VSPM by excluding extreme or outlier data points of the sunlight intensity data. For example, according to an implementation of the present disclosure, the VSPM can be generated by excluding data of a certain upper/lower ratio (e.g., 10%) of the sunlight intensity from the accumulated data as an outlier. Then, a VSPM can be constructed by matching the solar intensity corresponding to the remaining average data (e.g., 80% of the original data) with the GPS values thereof and displaying it as a heat map on the map. The heat map can represent different sunlight intensity data in different ways. For example, in the heat map, more intense sunlight can be represented by a darker color of red, and this can be updated on the map at different time intervals.

In some implementations, the map generation unit 22 updates the sunlight intensity heat map, which changes periodically, on the map at regular intervals.

For example, the map generation unit 22 constructs the VSPM once every time period (e.g., 30 minutes). In such scenarios, multiple maps (e.g., 24 in total) may be generated sequentially, e.g., one map in each of different periods during a 1-day weekly time period (e.g., 12 hours) (e.g., 1 map from AM 07:00 to AM 07:30, 1 map from AM 07:30 to AM 08:00, …, 1 map from PM 06:30 to PM 07:00).

The map generation unit 22 can generate and accumulate the multiple maps (e.g., a total of 24 maps) in at least one cycle of daily, weekly, monthly, seasonal, and annual periods. And, after quantifying the accumulated data, the data learned through an artificial intelligence (AI) machine-learning system can be converted into a database.

The map generation unit 22 may generate the VSPM at various geographic scales, for example for the entire country, and may further generate the VSPM for different countries in the above manner.

The DB 23 can store at least one program and data for the parking guidance of the solar panel-equipped vehicle 10 according to an implementation of the present disclosure, and stores information generated according to the operation of the server 20.

For example, the DB 23 stores the above VSPM and updates, e.g., periodically, the solar intensity information for each region over time.

The DB 23 can match the driver information and vehicle identification information (a vehicle/communication ID) of the vehicle 10 equipped with the solar panel to be registered and managed as a customer information. Therefore, based on the customer information, the solar power intensity messages can be obtained from the communication unit 21 and the recommended solar power charging parking location service can be provided.

The control unit 24 can be a central processing unit that controls the overall operation of the server 20 for providing the parking guidance service to the solar panel-equipped vehicle 10 according to an implementation of the present disclosure.

Below, a description of an example of the control unit 24 is provided which is also applicable to the operation of the server 20.

The control unit 24 can construct the VSPM (e.g., a nationwide VSPM) using the sunlight intensity periodically collected from a number of vehicles 10 for different geographic regions, and recommend (provide) the parking location with the strongest sunlight intensity from the customer's vehicle location based on the VSPM.

However, in some scenarios, even if the parking location with the strongest charging power is provided based on the vehicle location of the customer, there may be a problem in that the parking location cannot be used if another vehicle is already parked there.

To solve this problem, in some implementations, the control unit 24 can check whether the parking location is an available vacant parking location before providing the recommended solar charging parking location service to the customer vehicle 10.

In such implementations, the control unit 24 can collect the parking status of the outdoor parking lot into which the vehicle 10 has entered, identify an empty parking location on the detailed P-Map within the outdoor parking lot, and determine the recommended solar charging parking location with the strongest sunlight intensity among the currently empty parking locations, and transmit it to the vehicle 10. Accordingly, the vehicle 10 can set the recommended solar charging parking location as the final destination on the map P-Map in the outdoor parking lot of the VSPM and perform route guidance.

In some implementations, after the vehicle 10 has parked, the control unit 24 can receive the parking location when the vehicle 10 has parked, and after a certain period of the time (e.g., 1 hour) from the time of completion of parking, it may re-detect an updated recommended solar charging parking location among the currently empty parking locations and transmit it to the vehicle 10 or the user terminal 30.

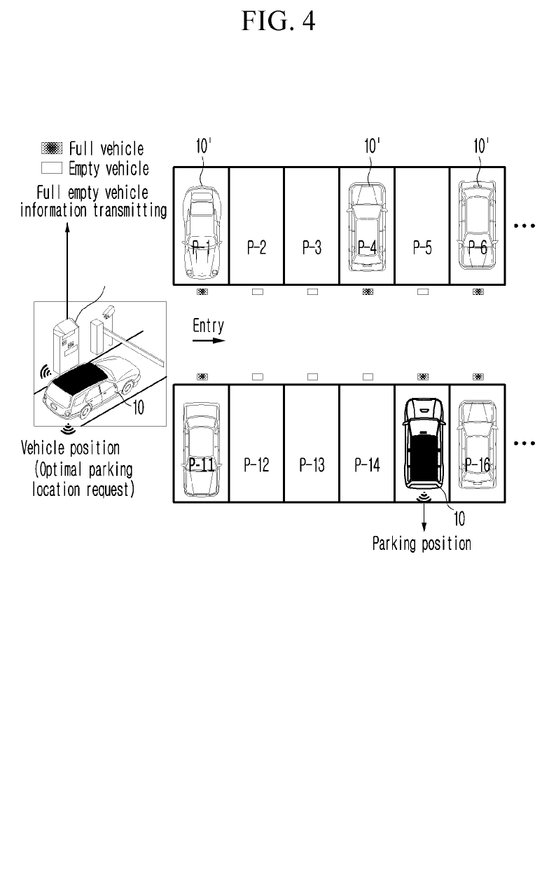

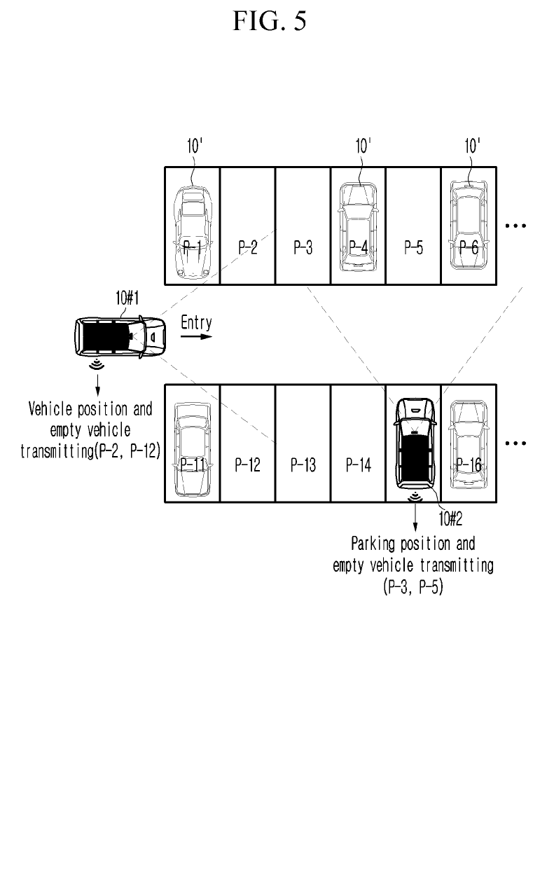

FIGS. 4 and 5 illustrate examples of techniques for identifying the parking status (an empty parking location) of the outdoor parking lot according to an implementation of the present disclosure.

First, FIG. 4 is a view illustrating an example of a method for identifying empty parking locations in an outdoor parking lot, based on occupied/unoccupied parking location information according to an implementation of the present disclosure.

Referring to FIG. 4, when the control unit 24 receives the request for the recommended solar charging parking location, e.g., when the vehicle 10 enters the outdoor parking lot, it can identify the outdoor parking lot entered based on the vehicle location and the entry time.

If there is the P-Map corresponding to the outdoor parking lot in the VSPM stored in the DB 23, the control unit 24 can change the navigation to the outdoor parking lot mode and activate the P-Map.

In some implementations, the control unit 24 detects a plurality of P-Maps (e.g., a total of 24) matching the outdoor parking lot from the DB 23 and detects a particular P-Map (hereinafter, referred to as the current P-Map) of the time corresponding to the entry point from among the plurality of P-Maps (a total of 24).

The control unit 24 collects the parking status of the current P-Map from the outdoor parking lot manager 40 and/or the customer vehicles 10 in the outdoor parking lot, identifies the empty parking locations, and matches them to the current P-Map.

In some implementations, the control unit 24 can collect the occupied/unoccupied parking location information from the parking lot manager 40 of the outdoor parking lot to identify empty parking locations (vacant parking locations). For example, the occupied/unoccupied parking location information can include information obtained from the parking lot manager 40 detecting the parking status of other vehicles 10' from a sensor installed in the individual parking space. The P-Map can display annotations indicating the occupied/unoccupied parking location information, e.g., in green (unoccupied space) or red (occupied space). Therefore, it can be easy to identify empty parking positions on the current P-Map.

Next, FIG. 5 is a view illustrating an example of a method for identifying empty parking locations in an outdoor parking lot without the occupied/unoccupied parking location information, according to an implementation of the present disclosure.

Referring to FIG. 5, in scenarios where the occupied/unoccupied parking location information is not available, the control unit 24 can identify empty parking locations (e.g., P-2, P-12) detected from an image captured by a front camera of a first customer vehicle (10#1) that enters and moves around the outdoor parking lot. The above image may be called an occupied/unoccupied parking location image and can be used to identify empty parking positions based on the vehicle position.

In some implementations, the control unit 24 can use the parking location (e.g. P-15) of a second customer vehicle (10#2) parked in the outdoor parking lot to determine whether the corresponding parking location is occupied. In addition, the control unit 24 can collect the occupied/unoccupied parking location images captured by the front camera based on the parking location (e.g., P-15) of the second customer vehicle (10#2) and identify the empty parking locations (e.g., P-3, P-5) remaining on the opposite side.

The control unit 24 can be implemented as one or more processors that operate the server 20 according to a set program. The above-described program may be programmed to perform each step of a parking guidance method of the solar panel-equipped vehicle in the server 20 according to an implementation of the present disclosure.

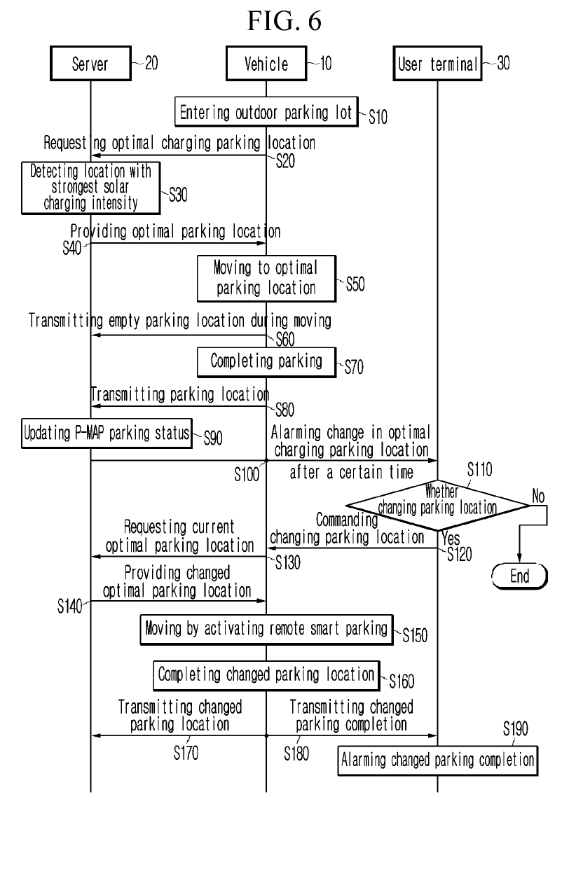

An example of this technique of guiding the parking of a vehicle equipped with solar panels is explained in more detail with reference to the examples and FIGS. 6-8 below.

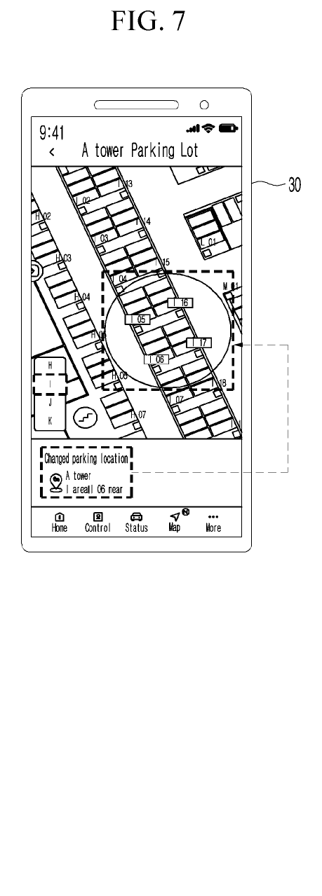

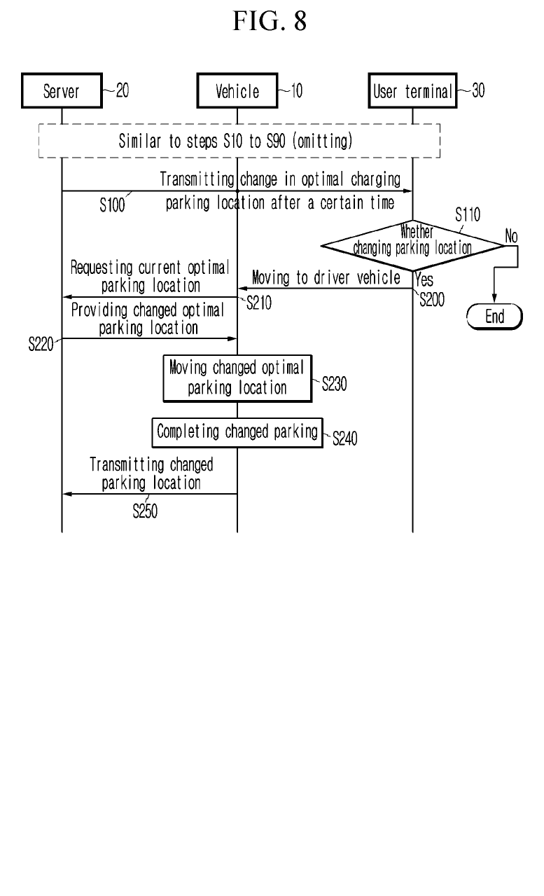

FIGS. 6 and 7 illustrate examples of a case (CASE 1) where there is the P-Map matching the outdoor parking lot into which the vehicle 10 has entered in the DB 23 of the server 20. FIG. 8 illustrates an example of a case (CASE 2) where there is no such matching P-Map.

FIG. 6 is a flowchart illustrating an example of a method for guiding a parking of a vehicle equipped with solar panels in a case (CASE 1) that there is an outdoor parking lot map (P-Map) in a DB of a server according to the first implementation of the present disclosure.

Referring to FIG. 6, the method for guiding parking of a vehicle equipped with a solar panel according to an implementation of the present disclosure begins with the server 20 constructing the VSPM by using the sunlight intensity collected from a number of vehicles distributed in different regions as described above.

When the vehicle 10 enters an outdoor parking lot (S10), a recommended charging parking location request, including the vehicle location and the entry time, is generated and transmitted to the server 20, e.g., via a wireless communication (S20).

The server 20 detects the recommended solar charging parking location with the strongest solar intensity based on the customer's vehicle location based on the VSPM matched to the outdoor parking lot according to the recommended charging parking location request (S30).

In some implementations, the process of detecting the recommended solar charging parking location includes extracting a P-Map of a time zone matching the entry point among the VSPMs stored in the DB 23 by the server 20, collecting the parking status of the outdoor parking lot and identifying the empty parking locations remaining on the P-Map, and determining the recommended solar charging parking location with the strongest solar intensity among the empty parking locations.

The server 20 can provide (e.g., transmit) the recommended solar charging parking location to the vehicle 10 via wireless communication (S40).

The vehicle 10 can set the recommended solar charging parking location as the final destination of the navigation system and move while performing the route guidance (S50).

In some implementations, the vehicle 10 can analyze the image captured by the front camera while moving to the recommended solar charging parking location to identify the remaining empty parking positions and transmit information regarding the same to the server 20 (S60).

When the vehicle 10 is parked in the recommended solar charging parking location (S70), the corresponding parking location (e.g., a GPS value) can be transmitted to the server 20 (S80). In some scenarios, the vehicle 10 may identify empty parking spaces remaining on the opposite side, e.g., through the front camera, after completing the parking. In such scenarios, the vehicle 10 can transmit information about the empty parking spaces to the server 20. In the above scenario, the empty parking location can be roughly identified as a relative location based on the GPS value (movement and parking) of the vehicle 10. For example, the vehicle 10 can identify the empty parking location estimated by at least one direction among east, west, south, and north and the distance on the P-Map based on the GPS value and transmit it to the server 20.

The server 20 can update the parking status of the corresponding P-Map by reflecting the empty parking location received from the vehicle 10 (S90). The above parking status updated in this way can be used to detect the recommended solar charging parking location among the empty parking locations remaining on the P-Map, as in the step (S30).

Below, the explanation continues assuming that there is the P-Map matching the outdoor parking lot into which the vehicle 10 entered in the DB 23 of the server 20, according to the CASE 1.

In some implementations, the server 20 or the vehicle 10 can transmit the change in the recommended solar charging parking location to the user terminal 30 after a certain period of the time (e.g., 1 hour) from the completion of the parking (S100).

The user terminal 30 can be an information and communication terminal carried by the driver (the customer), which can be a smartphone or a tablet PC, etc. The user terminal 30 can control the remote smart parking function to remotely move the vehicle 10 the recommended solar charging parking location changed by linking with the vehicle 10 through the installed connected service app (APP).

FIG. 7 is a view showing an example of a changed parking location alarm status of a user terminal according to an implementation of the present disclosure.

Referring to FIG. 7, the user terminal 30 displays the changed recommended solar charging parking location in the outdoor parking lot P-Map where the vehicle 10 is parked.

In some implementations, the user terminal 30 notifies the change in the recommended solar charging parking location to the driver and receives the input on whether or not to change the parking location (S110). In some implementations, if the driver does not change the parking location (S110; No), this logic ends. On the other hand, if the driver inputs the change in the parking location (S110; Yes), the user terminal 30 transmits the command to change the parking location to the vehicle 10 (S120).

The vehicle 10 can request the server 20 for the current recommended charging parking location according to the received parking location change command (S130).

Accordingly, the server 20 may re-detect the changed recommended solar charging parking location among the currently empty parking locations according to the above request and respond to the vehicle 10 (S140).

The vehicle 10 can move to the recommended solar charging parking location received from the server 20 as the destination, by activating the remote smart parking function (S150).

When the parking in the above-mentioned changed recommended solar charging parking location is completed (S160), the vehicle 10 can transmit the changed parking location to the server 20 and transmit the completion of the changed parking to the user terminal 30 (S170, 180).

The user terminal 30 can notify the completion of the changed parking position of the vehicle 10 to the driver and display the changed parking position on the P-Map (S190).

FIG. 8 is a flowchart showing an example of a method for guiding a parking of a vehicle equipped with a solar panel in a case where there is no outdoor parking lot map P-Map in a DB of a server according to the second implementation of the present disclosure (a CASE 2).

Referring to FIG. 8, the parking guidance method (the CASE 2) of the solar panel-equipped vehicle according to the second implementation of the present disclosure is similar to the steps (S10 to S90) of the first implementation (the CASE 1), so redundant description is omitted.

In S100, the server 20 or vehicle 10 can transmit a change in the recommended solar charging parking location to the user terminal 30 after a certain period of time (e.g., 1 hour) from the previous parking completion time (S100).

In some implementations, the user terminal 30 notifies the change in the recommended solar charging parking location to the driver (S110). Here, if the driver does not change the parking location (S110; No), this logic ends.

On the other hand, if the driver wants to change the parking location, in the second implementation (the CASE 2) of the present disclosure, since there is no the corresponding outdoor parking lot P-Map in the DB 23 of the server 20, the remote smart parking function is not possible, and so the driver moves to the vehicle (S200).

The vehicle 10 can request the server 20 for the recommended charging parking location at the current time according to the request of the driver (S210).

Accordingly, the server 20 can re-detect the changed recommended solar charging parking location among the currently empty parking locations according to the above request and provide it to the vehicle 10 (S220).

The vehicle 10 can set the changed recommended solar charging parking location as the final destination and move while performing the route guidance (S230).

In some implementations, when the vehicle 10 is completely parked at the recommended solar charging parking location (S240), it transmits the changed parking location (a GPS value) to the server 20 (S250).

Accordingly, the server 20 can update the approximate parking status of the outdoor parking lot by reflecting the empty parking location received when the vehicle 10 is moved and/or parked to the VSPM.

Although various examples of implementations of the present disclosure have been described above, the present disclosure is not limited to the above example implementations and various other modifications are possible.

For example, in the above-described implementation of the present disclosure, the server 20 mainly described as guiding the solar panel-equipped vehicle 10 to the recommended solar charging parking location when entering the outdoor parking lot. However, implementations of the present disclosure are not limited thereto, and can provide the recommended solar charging location based on the vehicle location according to the driver's request in various outdoor areas such as outdoor parks, stadiums, and campgrounds as well as outdoor parking lots.

Therefore, there is an advantage in that it may provide the recommended solar charging location when parking the vehicles in various outdoor locations such as food trucks, mobile office spaces, camping (a car camping), and performances, using the vehicles/PBVs equipped with the solar panels.

Implementations disclosed herein can provide various technical benefits. For example, a nationwide solar intensity map can be constructed using the solar intensity actually measured from the solar panel-equipped vehicles in the operation nationwide, and the map can be used to guide the customer vehicles to the parking locations with strong solar intensity, thereby improving the solar charging efficiency of the vehicles.

In addition, it has the effect of improving the customer satisfaction by guiding the vehicle to the solar charging location with the conditions optimized for the given environment, thereby increasing the solar charging efficiency and the usability of the solar panel options.

In addition, by increasing the distribution of the vehicles equipped with the solar panels as the solar charging efficiency improves, the effect of protecting the global natural environment may be expected by obtaining and utilizing the electric energy in an environmentally friendly manner.

The above-described example implementations of the present disclosure can be applied to programs that allow computers to execute functions corresponding to the configurations of the example implementations of the disclosure or recording media including the programs as well as the method and apparatus. Those skilled in the art can easily implement the applications from the above-described example implementations of the present disclosure.

While this disclosure has been described in connection with what is presently considered to be practical implementations, it is to be understood that the disclosure is not limited to the disclosed implementations. On the contrary, it is intended to cover various modifications and equivalent arrangements included within the spirit and scope of the appended claims.

What is claimed is:

1. A parking guidance system for a solar panel-equipped vehicle including a server, comprising:
at least one processor; and
at least one memory storing computer program instructions that, based on being executed by the at least one processor, perform operations comprising:
receiving, through a communications unit, solar intensity messages from solar panel-equipped vehicles, wherein for each vehicle, the solar intensity message comprises information regarding a solar intensity detected on a solar panel of the vehicle;
accumulating and processing the solar intensity messages over a period of time, and generating information regarding fluctuations of solar intensity across different time instances at different geographic locations;
generating a mapping of variable solar intensity in a vehicle parking area, based on the information regarding fluctuations of solar intensity;;
based on the mapping of variable solar intensity in the vehicle parking area, determining a recommended parking space in the vehicle parking area that satisfies at least one criteria for solar charging; and
transmitting, through the communications unit, information identifying the recommended parking space in the vehicle parking area that satisfies at least one criteria for solar charging.

2. The parking guidance system for the solar panel-equipped vehicle of claim 1, wherein:
for each vehicle, the solar intensity is measured based on an amount of a solar power generation or an electric energy charging amount per unit area of the solar panel over a duration of time.

3. The parking guidance system for the solar panel-equipped vehicle of claim 1, wherein:
generating the mapping of variable solar intensity in the vehicle parking area comprises generating information on the solar intensity that changes according to time, season, weather, and terrain for a navigation map of the vehicle parking area.

4. The parking guidance system for the solar panel-equipped vehicle of claim 1, wherein the operations further comprise:
obtaining, through the communications unit, information regarding a parking status of the vehicle parking area;
identifying an empty parking space based on the information regarding the parking status and based on the mapping of variable solar intensity in the vehicle parking area, and
determining the recommended parking space in which the solar intensity is maximum, among currently empty parking spaces in the vehicle parking area.

5. The parking guidance system for the solar panel-equipped vehicle of claim 4, wherein the accumulating and the processing of the solar intensity messages comprises:
analyzing the solar intensity message and identifying information regarding a solar intensity, a vehicle location, a time, and a vehicle ID; and
accumulating and storing the identified information regarding the solar intensity, the vehicle location, the time, and the vehicle ID into a database.

6. The parking guidance system for the solar panel-equipped vehicle of claim 4, wherein the generating of the mapping of variable solar intensity in the vehicle parking area comprises:
excluding, from the information regarding fluctuations of solar intensity, data for which the solar intensity satisfies an outlier criteria;
generating matching information between GPS values and the solar intensity of remaining data; and
generating a variable solar power map (VSPM)and displaying the VSPM on a map comprising a heat map, based on the matching information between the GPS values and the solar intensity of the remaining data.

7. The parking guidance system for the solar panel-equipped vehicle of claim 6, wherein the generating of the mapping of variable solar intensity in the vehicle parking area further comprises:
updating the heat map of the solar intensity that changes periodically at regular intervals to sequentially generate multiple maps over a length of time.

8. The parking guidance system for the solar panel-equipped vehicle of claim 4, wherein the operations further comprise:
generating a plurality of maps matched to the vehicle parking area across different instances of time;
obtaining, through the communications unit, information regarding a first time instance and a first geographic location of a first vehicle that enters the vehicle parking area; and
detecting a current map, among the plurality of maps, corresponding to first time instance of the first vehicle that enters the vehicle parking area.

9. The parking guidance system for the solar panel-equipped vehicle of claim 8, wherein the operations further comprise:
obtaining, through the communications unit, parking status information from a device other than the first vehicle;
determining, based on the parking status information, empty parking spaces in the vehicle parking area; and
matching the identified empty parking spaces to the current map among the plurality of maps.

10. The parking guidance system for the solar panel-equipped vehicle of claim 8, wherein the operations further comprise:
matching, to the current map among the plurality of maps, a movement of the first vehicle entering the vehicle parking area, and an empty parking space detected from an image captured by a front camera of a second vehicle parked in the vehicle parking area.

11. The parking guidance system for the solar panel-equipped vehicle of claim 4, wherein the operations further comprise:
receiving, through the communications unit, information regarding a parking location of a vehicle that has parked in the vehicle parking area, and
detecting, and transmitting to the vehicle, the recommended parking space among currently empty parking spaces locations after an interval of time has passed since the vehicle has parked in the vehicle parking area.

12. A solar panel-equipped vehicle parking guidance system including a vehicle, the system comprising:
a solar panel configured to convert solar energy into electrical energy and to generate a first DC voltage;
a solar charging controller configured to convert the first DC voltage into a second DC voltage that is chargeable to a battery to be charged;
a communications unit;
at least one processor; and
at least one memory storing computer program instructions that, based on being executed by the at least one processor, perform operations comprising:
generating a solar intensity message including information regarding at least one of a vehicle location, a time, and a vehicle ID associated with a solar intensity that is periodically measured by the solar charging controller,
transmitting the solar intensity message through the communications unit to a server; and
receiving, through the communications unit from the server, information identifying a recommended parking space for solar charging.

13. The solar panel-equipped vehicle parking guidance system of claim 12, wherein the operations further comprise:
based on a determination that the vehicle location corresponds to entering a vehicle parking area:
transmitting to the server a request for the information identifying the recommended parking space for solar charging; and
outputting, to a user interface, a route guidance that guides the vehicle to the recommended parking space for solar charging.

14. The solar panel-equipped vehicle parking guidance system of claim 1, further comprising:
a user terminal configured to control a remote smart parking function to remotely park the vehicle in the recommended parking space for solar charging, using a connection with the vehicle through a connected service app (APP).

15. A method for guiding a parking of a vehicle equipped with a solar panel, the method comprising:
receiving, through a communications unit, solar intensity messages from solar panel-equipped vehicles, wherein for each vehicle, the solar intensity message comprises information regarding a solar intensity detected on a solar panel of the vehicle;
accumulating and processing the solar intensity messages over a period of time, and generating a mapping of variable solar intensity in a vehicle parking area, based on the accumulated solar intensity messages;
receiving, through the communications unit from a first vehicle, a request for a recommended parking space in the vehicle parking area for solar charging, and information regarding a location of the first vehicle and an entry time at which the first vehicle enters the vehicle parking area,
based on the mapping of variable solar intensity in the vehicle parking area, determining the recommended parking space in the vehicle parking area as a parking space that satisfies at least one criteria for solar charging; and
transmitting, through the communications unit to the first vehicle, information identifying the recommended parking space in the vehicle parking area that satisfies at least one criteria for solar charging.

16. The method for guiding the parking of the vehicle equipped with the solar panel of claim 15, wherein generating the mapping of variable solar intensity in the vehicle parking area comprises:
analyzing the accumulated solar intensity messages and determining accumulated information of the vehicle location, the time, and the vehicle ID;
excluding, from the accumulated information, data for which the solar intensity satisfies an outlier criteria;
generating matching information between GPS values and the solar intensity of remaining data; and
generating a map comprising a heat map, based on the matching information between the GPS values and the solar intensity of the remaining data.

17. The method for guiding the parking of the vehicle equipped with the solar panel of claim 15, wherein determining the recommended parking space in the vehicle parking area comprises:
extracting a map, among a plurality of maps stored in a database, of the vehicle parking area for a time period matching the entry time at which the first vehicle enters the vehicle parking area;
obtaining information regarding a parking status of the vehicle parking area and identifying empty parking spaces remaining on the map; and
determining the recommended parking space for solar charging that satisfies the at least one criteria of having a solar intensity that is maximum among the empty parking locations.

18. The method for guiding the parking of the vehicle equipped with the solar panel of claim 17, further comprising:
after transmitting the information identifying the recommended parking space for solar charging to the first vehicle,
updating the parking status of the map by incorporating information regarding an empty parking spot detected from an image captured by a front camera of the first vehicle entering and moving around the vehicle parking area.

19. The method for guiding the parking of the vehicle equipped with the solar panel of claim 18, further comprising:
after updating the parking status of the map,
transmitting information regarding a change in the recommended parking space for solar charging to the user terminal, after a period of a time from a time of completion of parking of the first vehicle;
receiving, from the first vehicle, a request for a current recommended parking space for solar charging, based on a remote smart parking function activated in the first vehicle according to a command to change a parking location; and
re-detecting an updated recommended parking space for solar charging, among the empty parking spaces, according to the request received from the first vehicle.

20. The method for guiding the parking of the vehicle equipped with the solar panel of claim 16, wherein generating the mapping of variable solar intensity in the vehicle parking area comprises:
updating the heat map of the solar intensity that changes periodically at regular intervals on the map to sequentially generate multiple maps over a length of time.
